(19) United States
(12) Patent Application Publication
(10) Pub. No.: US 2024/0087798 A1
(43) Pub. Date: Mar. 14, 2024

(54) COIL COMPONENT AND METHOD OF MANUFACTURING THE SAME

(71) Applicant: TDK CORPORATION, Tokyo (JP)

(72) Inventors: Junichiro URABE, Tokyo (JP); Toshinori MATSUURA, Tokyo (JP); Hajime KATO, Tokyo (JP); Shintarou KOIKE, Tokyo (JP); Kazushige TOHTA, Tokyo (JP); Takuto KAZAMA, Tokyo (JP); Masashi GOTOH, Tokyo (JP)

(73) Assignee: TDK CORPORATION, Tokyo (JP)

(21) Appl. No.: 18/304,066

(22) Filed: Apr. 20, 2023

(30) Foreign Application Priority Data
Sep. 9, 2022 (JP) 2022-143908

(51) Int. Cl. H01F 27/29; H01F 27/28; H01F 41/076

(52) U.S. Cl. CPC H01F 27/292; H01F 27/2828; H01F 41/076

(57) ABSTRACT

A coil component includes a coil configured of a winding, an exterior body provided to cover the coil, and a terminal part configured to be continuous with the winding. A proximal end portion of the terminal part is buried in the exterior body. A distal end portion ahead of the proximal end portion is bent from the proximal end portion and located outside a mounting surface of the exterior body along the mounting surface.

### TECHNICAL FIELD

The present disclosure relates to a coil component and a method of manufacturing the coil component.

### BACKGROUND

A conventional coil component is disclosed, for example, in Japanese Unexamined Patent Publication No. 2015-70154. The coil component includes a coil configured of a winding, a core around which the winding is wound, an exterior body that covers substantially the entirety of the coil and the core, and a terminal part connected to the winding. The winding is drawn out to a surface of the exterior body that does not intersect a central axis of the coil.

### SUMMARY

In the coil component as described above, the terminal part connected to the winding is joined to an electrode pad or the like of a substrate by soldering or the like when the coil component is mounted on the substrate. However, when the coil is sealed with the exterior body and a member (for example, a resin) forming the exterior body infiltrates to a mounting surface of the terminal part, a mounting area of the terminal part is reduced, and there is a risk that a bonding strength between the terminal part and the substrate will be insufficient. In addition, in the viewpoint of curbing separation and breakage of the terminal part, sufficient strength of the terminal part itself is required.

The present disclosure has been made to solve the above problems, and an object thereof is to provide a coil component and a method of manufacturing the coil component that can sufficiently ensure both the strength of the terminal part itself and a joining strength between the terminal part and the substrate.

A coil component according to one aspect of the present disclosure includes a coil configured of a winding, an exterior body provided to cover the coil, and a terminal part configured to be continuous with the winding, wherein a proximal end portion of the terminal part is buried in the exterior body, and a distal end portion ahead of the proximal end portion is bent from the proximal end portion and located outside a surface of the exterior body along the surface.

In the coil component, in the terminal part, the distal end portion ahead of the proximal end portion is bent from the proximal end portion and located outside a surface of the exterior body along the surface. The terminal part can be formed by bending the distal end portion of the terminal part from the proximal end portion after the exterior body that covers the coil is formed. Therefore, when the coil is sealed with the exterior body, it is possible to avoid that the member (for example, a resin) forming the exterior body infiltrates to a mounting surface of the terminal part. Due to the infiltration of the member to the mounting surface being avoided, a mounting area of the terminal part becomes sufficient, and a joining strength between the terminal part and the substrate can be sufficiently ensured. Further, in the coil component, the proximal end portion of the terminal part is buried in the exterior body. Therefore, a strength of the terminal part itself can be sufficiently ensured, and separation and breakage of the terminal part can be curbed.

The terminal part may have a flat shape with a thickness smaller than a diameter of the winding, and the proximal end portion may have a flared shape of which a width gradually widens toward the distal end portion. According to such a terminal part, it is possible to ensure a more sufficient mounting area for the terminal part at the distal end portion located outside the surface of the exterior body. In addition, since the proximal end portion of which a width changes in a flared shape is buried in the exterior body, the strength of the terminal part itself can be more sufficiently secured.

The distal end portion may protrude more than the coil in an extending direction of a central axis of the coil. Thus, the mounting area of the terminal part becomes more sufficient, and the joining strength between the terminal part and the substrate can be further improved.

The winding may have a connection portion with the terminal part; and the connection portion may be bent inward toward the central axis of the coil. In this case, it is possible to curb protrusion of the terminal part from the exterior body, and it is possible to reduce a size of the coil component. Also, a pressing force applied to the terminal part during mounting of the coil component can be reduced. This contributes to improving reliability of the coil component after mounting.

A method of manufacturing a coil component according to one aspect of the present disclosure includes a winding processing step of forming a coil with a winding and a terminal part continuous with the winding, an exterior body forming step of forming an exterior body to cover the coil and to bury a proximal end portion of the terminal part, and a bending step of bending the distal end portion from the proximal end portion so that the distal end portion ahead of the proximal end portion is located outside a surface of the exterior body along the surface.

In the method of manufacturing a coil component, After the exterior body that covers the coil is formed, the distal end portion of the terminal part is bent from the proximal end portion to locate the distal end portion outside the surface of the exterior body along the surface. Therefore, when the coil is sealed with the exterior body, it is possible to avoid that the member (for example, a resin) forming the exterior body infiltrates to the mounting surface of the terminal part. Due to the infiltration of the member to the mounting surface being avoided, the mounting area of the terminal part becomes sufficient, and the joining strength between the terminal part and the substrate can be sufficiently ensured. Further, in the method of manufacturing the coil component, the proximal end portion of the terminal part is buried in the exterior body. Therefore, the strength of the terminal part itself can be sufficiently ensured, and separation and breakage of the terminal part can be curbed.

A terminal part forming step of forming the terminal part so that the terminal part has a flat shape with a thickness smaller than a diameter of the winding, and the proximal end portion has a flared shape of which a width gradually widens toward the distal end portion may be included between the winding processing step and the exterior body forming step. According to such a terminal part, it is possible to secure a more sufficient mounting area for the terminal part at the distal end portion located outside the surface of the exterior body. In addition, since the proximal end portion of which a width changes in a flared shape is buried in the exterior body, the strength of the terminal part itself can be more sufficiently secured.

In the bending step, the distal end portion may protrude more than the coil in an extending direction of a central axis of the coil. Thus, the mounting area of the terminal part becomes more sufficient, and the joining strength between the terminal part and the substrate can be further improved.

In the winding processing step, a portion of the winding connected to the terminal part may be bent inward toward the central axis of the coil. In this case, it is possible to curb protrusion of the terminal part from the exterior body, and it is possible to reduce the size of the coil component. Also, a pressing force applied to the terminal part during mounting of the coil component can be reduced. This contributes to improving the reliability of the coil component after mounting.

### BRIEF DESCRIPTION OF THE DRAWINGS

FIG. 1 is a schematic perspective view of a coil component according to an embodiment of the present disclosure.

FIG. 2 is a schematic perspective view of the coil component shown in FIG. 1 when seen from the terminal part side.

FIG. 3 is a schematic front view of the coil component shown in FIG. 1 when seen from a central axis direction of a coil.

FIG. 4 is a perspective view showing a configuration of a terminal part.

FIG. 5 is an enlarged perspective view of a main part in the vicinity of the terminal part.

FIG. 6 is an enlarged cross-sectional view of the main part in the vicinity of the terminal part.

FIG. 7 is a flowchart showing an example of a method of manufacturing the coil component shown in FIG. 1.

FIG. 8 is a schematic perspective view showing a winding processing step.

FIG. 9 is a schematic perspective view showing a step subsequent to that of FIG. 8.

FIG. 10 is a schematic perspective view showing a terminal part forming step.

FIG. 11 is a schematic perspective view showing an exterior body forming step.

FIG. 12 is a schematic perspective view showing a bending step.

FIG. 13 is a schematic front view showing a modified example of the terminal part.

### DETAILED DESCRIPTION

Hereinafter, a preferred embodiment of a coil component and a method for manufacturing the coil component according to one aspect of the present disclosure will be described in detail with reference to the drawings.

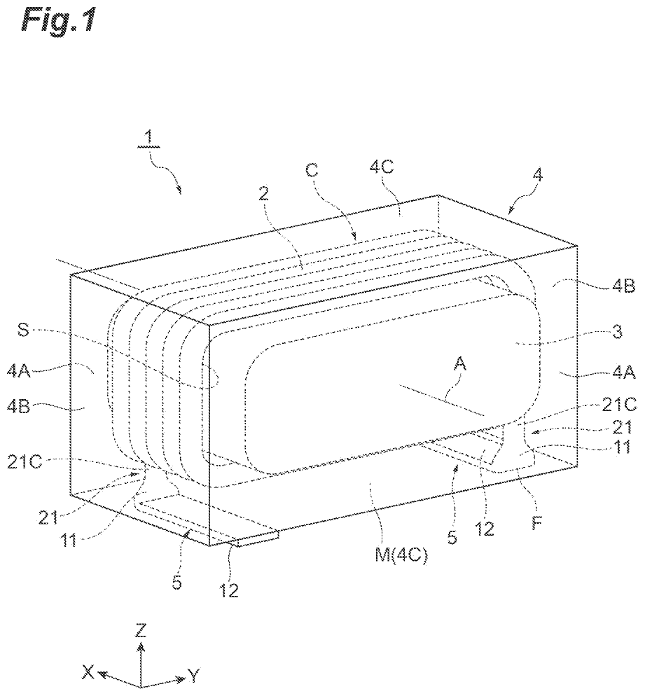

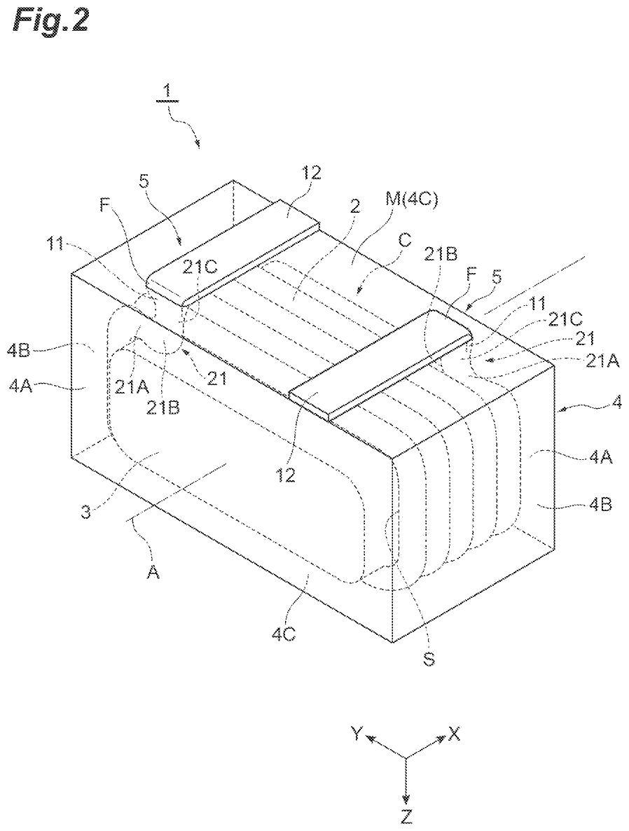

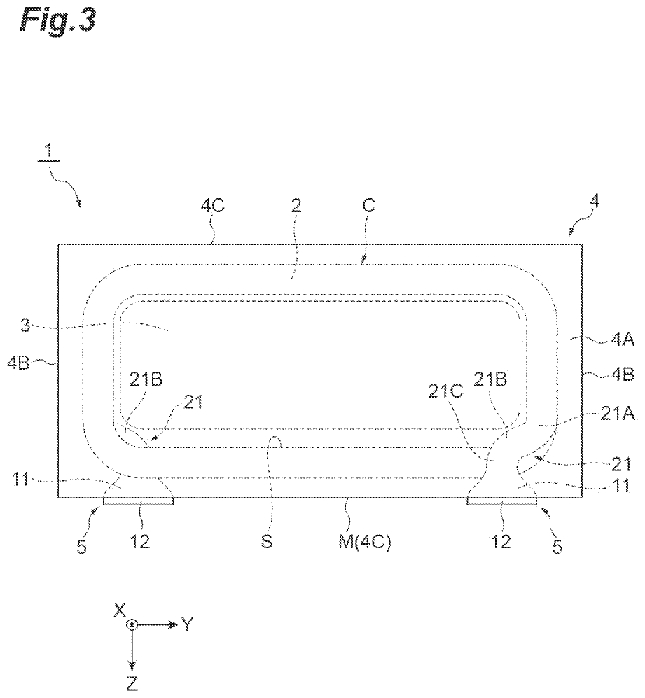

FIG. 1 is a schematic perspective view of a coil component according to an embodiment of the present disclosure. FIG. 2 is a schematic perspective view of the coil component shown in FIG. 1 when seen from the terminal part side. FIG. 3 is a schematic front view of the coil component shown in FIG. 1 when seen from a central axis direction of the coil. As shown in FIGS. 1 to 3, the coil component 1 includes a coil C configured by a winding 2, a core 3 inserted into an inner region S (refer to FIG. 3) of the coil C, an exterior body 4 provided to cover the core 3 and the coil C, and a pair of terminal parts 5 and 5 that are continuous with the winding 2.

The coil C is configured by winding the winding 2 in a spiral. The coil C is wound around the outside of the core 3. In the following description, a direction along a central axis A of the coil C is an X-axis direction, a direction orthogonal to the X-axis is a Y-axis direction, and a direction orthogonal to the X-axis direction and the Y-axis direction is a Z-axis direction. The winding 2 has a conducting wire portion made of a conductive material. A constituent material of the conducting wire portion includes, for example, metal materials such as copper, silver, nickel, and chromium, or the like. The conducting wire portion may be covered with a covering portion made of an electrically insulating material. A constituent material of the covering portion includes, for example, polyurethane.

The coil C has a plurality of turns. The plurality of turns are arranged in the X-axis direction. An inner region S of the coil C is defined by the plurality of turns. As shown in FIG. 3, a shape of the inner region S is, for example, a substantially rectangular shape with rounded corner portions when seen in the X-axis direction. The shape of the inner region S may be other shapes such as a circular shape, an elliptical shape, and an oval shape.

The core 3 has, for example, a substantially rectangular parallelepiped shape. The core 3 extends in the X-axis direction according to the number of turns of the coil C. The core 3 may have a shape with chamfered corner portions and ridge portions, or a shape with rounded corner portions and ridge portions. A flange portion that restricts movement of the coil C in the X-axis direction may be provided at an end portion of the core 3 in the X-axis direction. The core 3 is made of a material such as a resin, ferrite, alumina, or the like. The shape of the core 3 may be other shapes such as a cylindrical shape.

The exterior body 4 has a substantially rectangular parallelepiped shape. The core 3 may have a shape with chamfered corner portions and ridge portions, or a shape with rounded corner portions and ridge portions. The exterior body 4 has six surfaces. Here, a pair of surfaces in the X-axis direction are referred to as end surfaces 4A and 4A, and a pair of surfaces in the Y-axis direction are referred to as side surfaces 4B and 4B. A pair of surfaces in the Z-axis direction are referred to as main surfaces 4C and 4C. One of the main surfaces 4C and 4C serves as a mounting surface M for mounting the coil component 1 on a substrate (not shown). A pair of terminal parts 5 and 5 that are continuous with the winding 2 are drawn out from the mounting surface M. The coil component 1 is mounted on the substrate by joining the terminal parts 5 and 5 to the electrode pads of the substrate by soldering or the like.

The exterior body 4 is made of a resin, for example. Examples of the resin material forming the exterior body 4 include a liquid crystal polymer, a polyimide resin, crystalline polystyrene, an epoxy resin, a fluorine resin, and the like. The polyimide resin may be a bismaleimide resin. The fluorine resin may be a polytetrafluoroethylene resin. The resin material may contain fillers, impurities, and the like for enhancing properties of the coil component 1.

Next, a configuration of the terminal part 5 will be described.

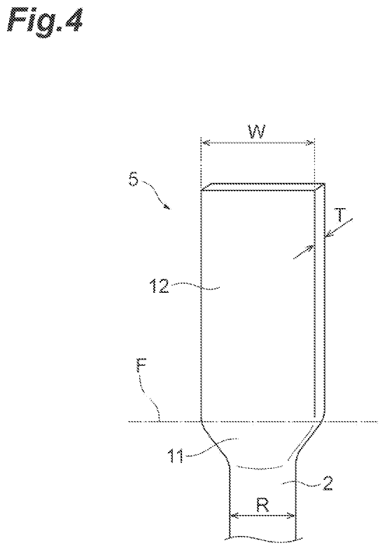

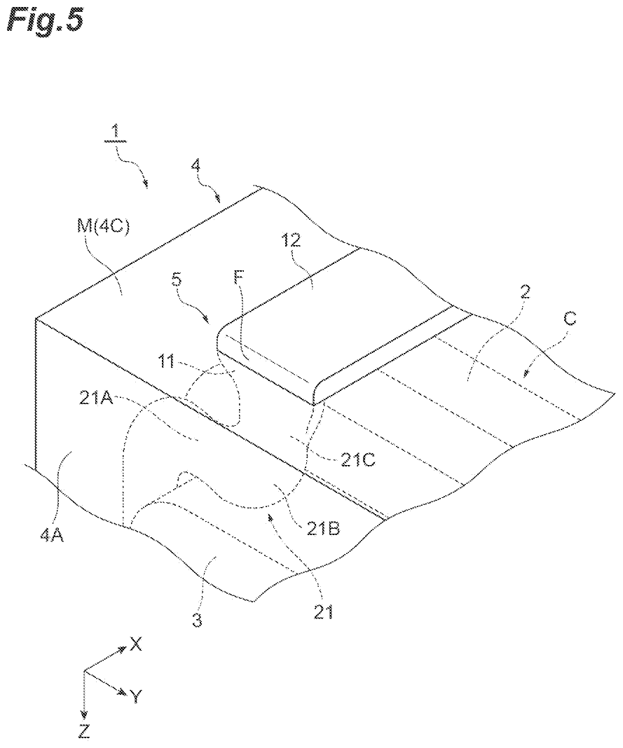

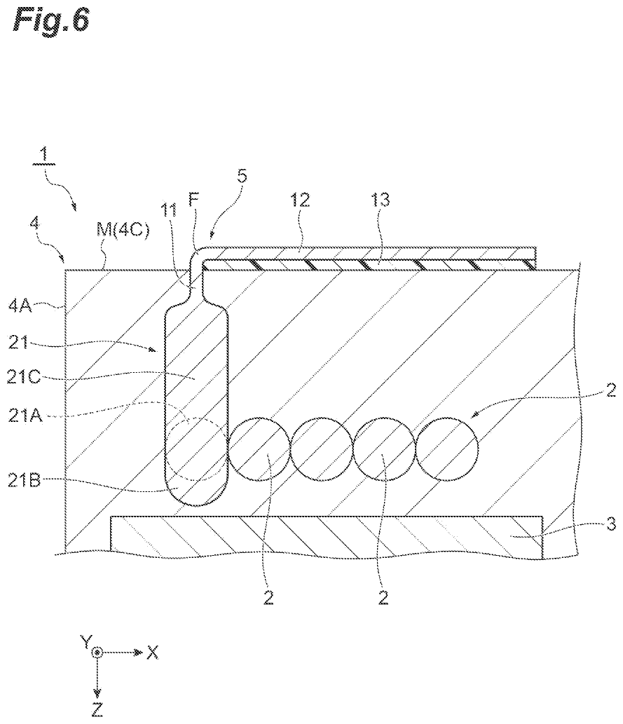

FIG. 4 is a perspective view showing the configuration of the terminal part. FIG. 5 is an enlarged perspective view of a main portion in the vicinity of the terminal part, and FIG. 6 is an enlarged cross-sectional view of the main portion in the vicinity of the terminal part. FIGS. 4 to 6 show one terminal part 5 and the vicinity thereof, but the other terminal part 5 and the vicinity thereof have the same structure. As shown in FIG. 4, the terminal part 5 is formed into a flat shape (a plate shape) with a thickness T smaller than a diameter R of the winding 2 by forming the end portion of the winding 2 by press working or the like, for example.

In the present embodiment, the terminal part 5 has a proximal end portion 11 and a distal end portion 12 ahead of the proximal end portion 11, as shown in FIG. 4. The proximal end portion 11 has a flared shape that widens gradually toward the distal end portion 12. The distal end portion 12 is continuous with the proximal end portion 11 and extends longer than the proximal end portion 11 with a substantially constant width W. In the present embodiment, a width W of the distal end portion 12 is equal to the maximum width of the proximal end portion 11 that has a flared shape.

In the present embodiment, as will be described below, the terminal part 5 is bent at a boundary portion F between the proximal end portion 11 and the distal end portion 12, and the proximal end portion 11 and the distal end portion 12 are conveniently determined based on a bent portion. In the actual terminal part 5, the width W of the distal end portion 12 may not necessarily be constant. In this case, for example, the boundary portion F between the proximal end portion 11 and the distal end portion 12 may be determined based on a ratio of a length to the entire length of the terminal part 5, and the boundary portion F between the proximal end portion 11 and the distal end portion 12 may be determined based on a flared extent to which the width of the portion forming the flared shape (an inclination of an edge portion with respect to the central axis in the width direction of the terminal part 5).

The proximal end portion 11 is buried in the exterior body 4 as shown in FIGS. 5 and 6. In the present embodiment, the proximal end portion 11 is continuous with the winding 2 and extends toward the mounting surface M in the Z-axis direction. The boundary portion F between the proximal end portion 11 and the distal end portion 12 is exposed on the mounting surface M. The distal end portion 12 is bent in the X-axis direction from the proximal end portion 11 at the boundary portion F and located outside the mounting surface M along a surface (here, the mounting surface M) of the exterior body 4. The distal end portion 12 is located in a region overlapping the coil C when the coil component 1 is seen in the Z-axis direction, and extends in the X-axis direction (refer to FIGS. 2 and 6). The distal end portion 12 may be joined to the mounting surface M by an adhesive layer 13, for example, as shown in FIG. 6.

The distal end portion 12 protrudes more than the coil C in an extending direction of the central axis A of the coil C (the X-axis direction). Here, the distal end portion 12 extends to an edge of the mounting surface M in the X-axis direction, and an edge of the distal end portion 12 in the X-axis direction coincides with the edge of the mounting surface M in the X-axis direction. The distal end portion 12 may protrude beyond the edge of the mounting surface M in the X-axis direction. The distal end portion 12 may not necessarily have to extend to the edge of the mounting surface in the X-axis direction, and the edge of the distal end portion 12 in the X-axis direction may be located inside the edge of the mounting surface M in the X-axis direction.

The winding 2 has a connection portion 21 with the terminal part 5. In the present embodiment, the connection portion 21 is configured integrally with the terminal part 5 by the winding 2 itself. The connection portion 21 is bent inward toward the central axis A of the coil C. Specifically, in the present embodiment, as shown in FIGS. 3 and 5, the connection portion 21 has a first portion 21A that is continuous with the coil C and extends in the Y-axis direction toward the core 3, a second portion 21B that is bent in the Z-axis direction from a distal end of the first portion 21A, and a third portion 21C that extends in the Z-axis direction from a distal end of the second portion 21B toward the proximal end portion 11 of the terminal part 5 and is continuous with the proximal end portion 11.

The first portion 21A, the second portion 21B, and the third portion 21C are all located inside the exterior body 4. In the present embodiment, as shown in FIG. 3, when seen in the extending direction of the central axis of the coil C (the X-axis direction), the first portion 21A slightly protrudes into the inner region S of the coil C to such an extent that the arrangement of the core 3 is not hindered. Similarly, when seen in the extending direction of the central axis of the coil C (the X-axis direction), the second portion 21B slightly protrudes into the inner region S of the coil C to such an extent that the arrangement of the core 3 is not hindered.

Since the first portion 21A and the second portion 21B protrude to the inner region S of the coil C, the third portion 21C is located inside the coil C in the Y-axis direction when seen in the extending direction of the central axis of the coil C (X-axis direction). Thus, the proximal end portion 11 that is continuous with the connection portion 21 is located inside the coil C in the Y-axis direction, and the distal end portion 12 ahead of the proximal end portion 11 is located in a region overlapping the exterior body 4 when seen in the Z-axis direction.

Next, a method of manufacturing the coil component 1 described above will be described.

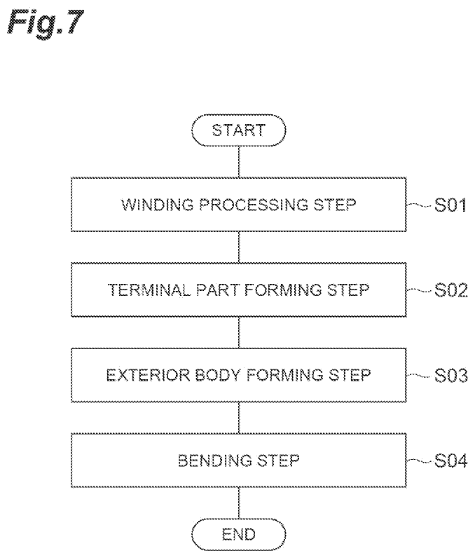

FIG. 7 is a flowchart showing an example of a method of manufacturing the coil component shown in FIG. 1. As shown in FIG. 7, the method of manufacturing the coil component 1 includes a winding processing step (Step S01), a terminal part forming step (Step S02), an exterior body forming step (Step S03), a bending step (Step S04).

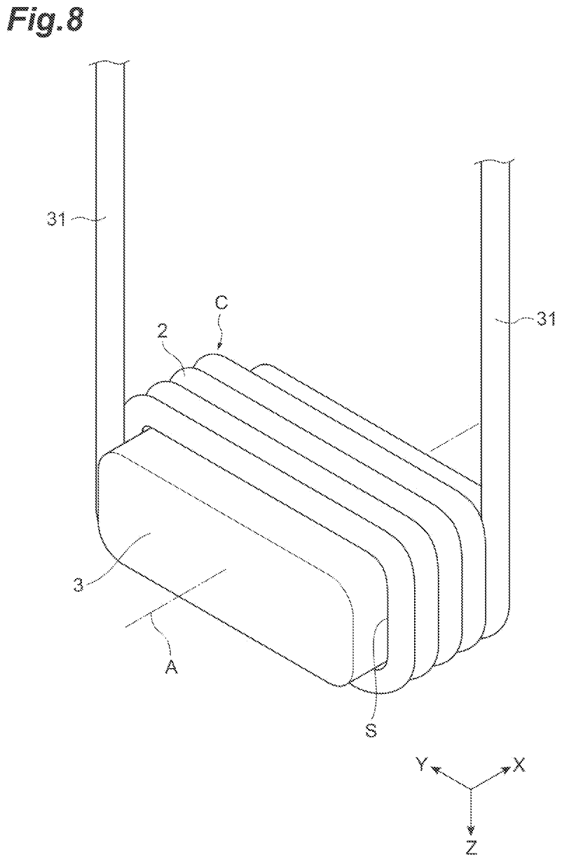

In the winding processing step, as shown in FIG. 8, first, a winding 2 is prepared, and a coil C is formed by spirally winding the winding 2 around the core 3. Surplus portions 31 which will later become the connection portion 21 and the terminal part 5 are provided at both ends of the coil C. Alternatively, the coil C and the surplus portions 31 may be formed in advance, and the core 3 may be inserted through the inner region S of the coil C.

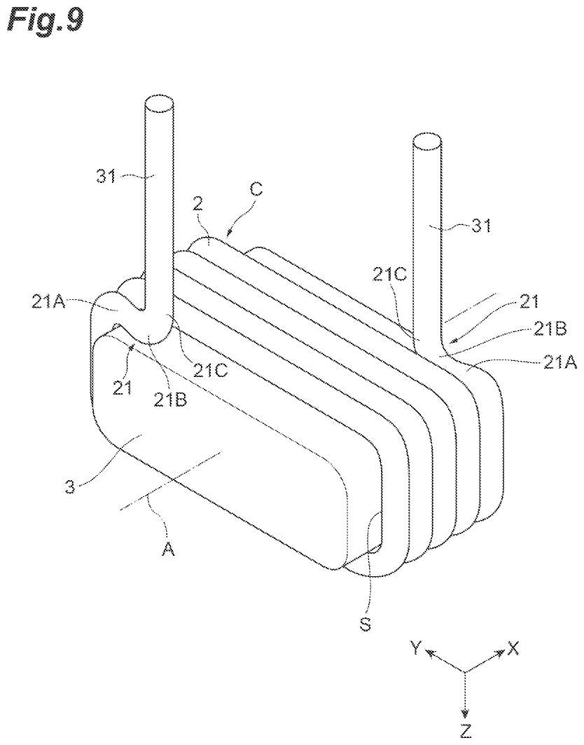

Next, as shown in FIG. 9, the proximal end sides of the surplus portions 31 and 31, that is, portions that will become the connection portions 21 between the coil C and the terminal parts 5 are bent inward toward the central axis A of the coil C. Here, the first portion 21A, the second portion 21B, and the third portion 21C are formed, and the connection portions 21 are formed to protrude slightly into the inner region S of the coil C. The surplus portion 31 ahead of the connection portion 21 is extended in the Z-axis direction, and the distal end side thereof is cut off leaving a portion that will become the terminal part 5 later.

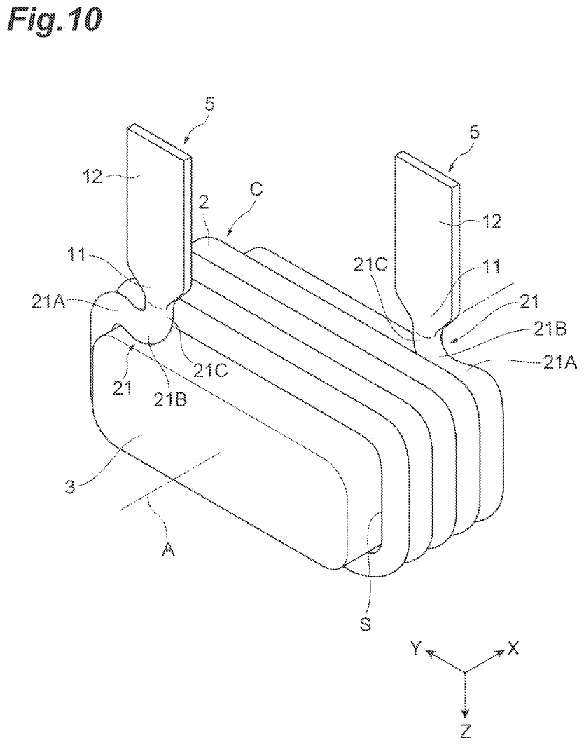

In the terminal part forming step, as shown in FIG. 10, the terminal part 5 is formed using the surplus portion 31. In forming the terminal part 5, the surplus portion 31 is formed by press working or the like. Thus, in the terminal part 5, the distal end portion 12 having a flat shape with a thickness T smaller than the diameter R of the winding 2 and the proximal end portion 11 having a flared shape of which a width gradually widens toward the distal end portion 12 are formed at the same time.

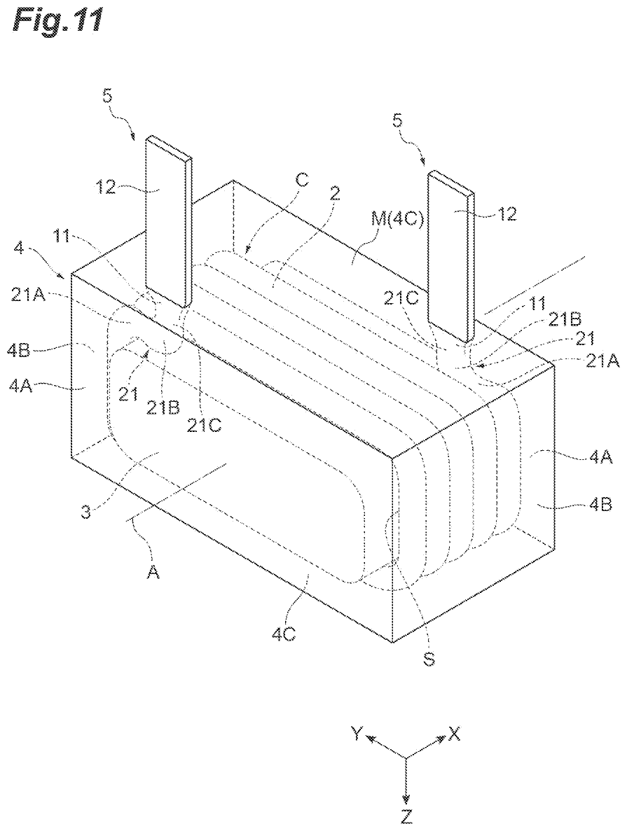

In the exterior body forming step, as shown in FIG. 11, the exterior body 4 is formed to cover the core 3 and the coil C. In forming the exterior body 4, for example, the core 3 and the coil C are disposed in a mold, and a resin material that forms the exterior body 4 is poured into the mold. Here, the exterior body 4 is formed to cover the coil C and to bury the proximal end portion 11 of the terminal part 5. The distal end portion 12 of the terminal part 5 is not buried in the exterior body 4 and protrudes outside the mounting surface M. After the resin material is cooled, the core 3 and the coil C covered with the exterior body 4 are removed from the mold.

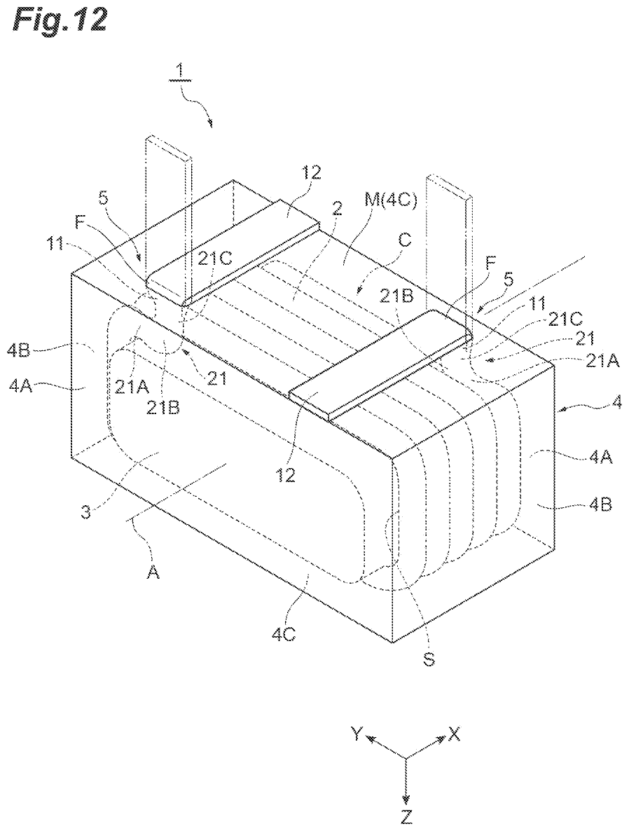

In the bending step, as shown in FIG. 12, the distal end portion 12 of the terminal part 5 is bent from the proximal end portion 11. Here, the distal end portion 12 that protrudes outside the mounting surface M is bent toward the mounting surface M of the exterior body 4 and located outside the mounting surface along the mounting surface M of the exterior body 4. Since the bending step is performed after the exterior body forming step is performed, a part of the distal end portion 12 is not buried in the exterior body 4, and the entire distal end portion 12 is exposed outside the mounting surface M.

In the bending step, the distal end portion 12 protrudes more than the coil C in the extending direction of the central axis A of the coil C. An amount of protrusion of the distal end portion 12 with respect to the coil C can be adjusted, for example, by adjusting a cutting position of the surplus portion 31 in the winding processing step or by pressing conditions for the surplus portion in the terminal part forming step. After the bending step, the distal end portion 12 and the mounting surface M are joined by the adhesive layer 13 as necessary, and the coil component 1 described above is completed.

As described above, in the coil component 1, in the terminal part 5, the distal end portion 12 ahead of the proximal end portion 11 is bent from the proximal end portion 11 and located outside the mounting surface M along the mounting surface M of the exterior body 4. The terminal part 5 can be formed by bending the distal end portion 12 of the terminal part 5 from the proximal end portion 11 after the exterior body 4 that covers the coil C is formed. Therefore, when the coil C is sealed with the exterior body 4, it is possible to avoid that a member (for example, a resin) forming the exterior body 4 infiltrates to the mounting surface M of the terminal part 5. Due to the infiltration of the member to the mounting surface M being avoided, a mounting area of the terminal part 5 becomes sufficient, and thus a joining strength between the terminal part 5 and the substrate can be sufficiently ensured. Moreover, in the coil component 1, the proximal end portion 11 of the terminal part 5 is buried in the exterior body 4. Therefore, the strength of the terminal part 5 itself can be sufficiently ensured, and separation and breakage of the terminal part 5 can be curbed.

In the present embodiment, the terminal part 5 has a flat shape with the thickness T smaller than the diameter R of the winding 2, and the proximal end portion 11 has a flared shape of which a width gradually widens toward the distal end portion 12. According to such a terminal part 5, the mounting area of the terminal part 5 can be more sufficiently ensured at the distal end portion 12 located outside the mounting surface M of the exterior body 4. In addition, since the proximal end portion 11 of which the width changes in the flared shape is buried in the exterior body 4, the strength of the terminal part 5 itself can be more sufficiently ensured.

In the present embodiment, the distal end portion 12 protrudes more than the coil C in the extending direction of the central axis A of the coil C. As a result, the mounting area of the terminal part 5 becomes more sufficient, and the joining strength between the terminal part 5 and the substrate is further improved.

In the present embodiment, the winding 2 has the connection portion 21 with the terminal part 5. The connection portion 21 is bent inward toward the central axis A of the coil C. It is possible to curb protruding of the terminal part 5 from the exterior body 4 by forming the connection portion 21 in this way, and a size of the coil component 1 can be reduced. Moreover, a pressing force applied to the terminal part when the coil component 1 is mounted can be reduced. This contributes to improving reliability of the coil component 1 after mounting.

The present disclosure is not limited to the above embodiment. For example, in the above embodiment, the proximal end portion 11 extends in the Z-axis direction (located in the Z-axis direction), but the proximal end portion 11 may be inclined with respect to the Z-axis direction. Further, in the above embodiment, in the terminal part 5, the proximal end portion 11 is the portion that forms a flared shape, the distal end portion 12 is the portion that has a constant width, and the terminal part 5 is bent at the boundary portion F between the proximal end portion 11 and the distal end portion 12, but the bending position of the terminal part 5 is not limited thereto. For example, the portion that forms the flared shape may be bent, or the portion that has a constant width may be bent.

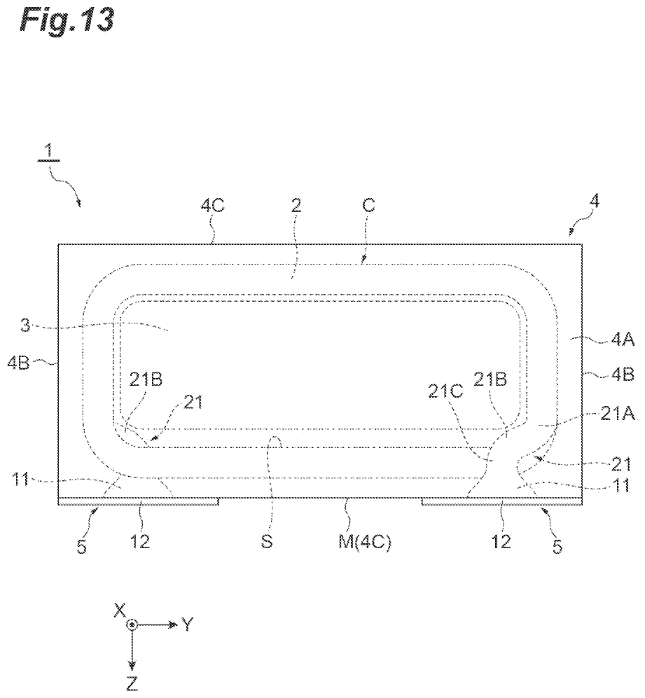

The distal end portion 12 does not necessarily have to be bonded to the mounting surface M by the adhesive layer 13. In this case, the distal end portion 12 may be in contact with the mounting surface M without interposing the adhesive layer 13, or may be slightly separated from the mounting surface M. As shown in FIG. 13, the distal end portion 12 may extend to the edge of the mounting surface M in the Y-axis direction. The distal end portion 12 may protrude beyond the edge of the mounting surface M in the Y-axis direction.

In the above embodiment, the distal end portion 12 extends in the X-axis direction outside the mounting surface M, but the extending direction of the distal end portion 12 may be the Y-axis direction. In this case, the distal end portion 12 may extend to the edge of the mounting surface M in the Y-axis direction, or may protrude beyond the edge of the mounting surface M in the Y-axis direction. The distal end portion 12 does not necessarily have to extend to the edge of the mounting surface M in the Y-axis direction, and the edge of the distal end portion 12 in the Y-axis direction may be located inside the edge of the mounting surface M in the Y-axis direction.

In the above embodiment, the core 3 is inserted through the inner region S of the coil C, but the core 3 may not necessarily be disposed. In the above embodiment, although the connection portion 21 is bent inward toward the central axis A of the coil C by the first portion 21A, the second portion 21B, and the third portion 21C, the connection portion 21 does not necessarily have such an inward bend. That is, the connection portion 21 may extend linearly in the Z-axis direction continuously from a portion of the coil C extending in the Z-axis direction.

What is claimed is:

1. A coil component comprising:
a coil configured of a winding;
an exterior body provided to cover the coil; and
a terminal part configured to be continuous with the winding,
wherein a proximal end portion of the terminal part is buried in the exterior body, and
a distal end portion ahead of the proximal end portion is bent from the proximal end portion and located outside a surface of the exterior body along the surface.

2. The coil component according to claim 1, wherein:
the terminal part has a flat shape with a thickness smaller than a diameter of the winding; and
the proximal end portion has a flared shape of which a width gradually widens toward the distal end portion.

3. The coil component according to claim 1, wherein the distal end portion protrudes more than the coil in an extending direction of a central axis of the coil.

4. The coil component according to claim 1, wherein:
the winding has a connection portion with the terminal part; and
the connection portion is bent inward toward the central axis of the coil.

5. A method of manufacturing a coil component, comprising:
a winding processing step of forming a coil with a winding and a terminal part continuous with the winding;
an exterior body forming step of forming an exterior body to cover the coil and to bury a proximal end portion of the terminal part; and
a bending step of bending the distal end portion from the proximal end portion so that the distal end portion ahead of the proximal end portion is located outside a surface of the exterior body along the surface.

6. The method of manufacturing a coil component according to claim 5, wherein a terminal part forming step of forming the terminal part so that the terminal part has a flat shape with a thickness smaller than a diameter of the winding, and the proximal end portion has a flared shape of which a width gradually widens toward the distal end portion is included between the winding processing step and the exterior body forming step.

7. The method of manufacturing a coil component according to claim 5, wherein, in the bending step, the distal end portion protrudes more than the coil in an extending direction of a central axis of the coil.

8. The method of manufacturing a coil component according to claim 5, wherein, in the winding processing step, a portion of the winding connected to the terminal part is bent inward toward the central axis of the coil.
